(19) United States
(12) Patent Application Publication
(10) Pub. No.: US 2025/0187783 A1
(43) Pub. Date: Jun. 12, 2025

(54) PACKAGING AND METHOD FOR PRODUCING A PACKAGING

(71) Applicant: MULTIVAC MARKING & INSPECTION GMBH & CO. KG, Enger (DE)

(72) Inventors: Michael REFFKE, Rödinghausen (DE); Ronald HELMEL, Seeboden (AT)

(73) Assignee: MULTIVAC MARKING & INSPECTION GMBH & CO. KG, Enger (DE)

(21) Appl. No.: 18/975,641

(22) Filed: Dec. 10, 2024

(30) Foreign Application Priority Data
Dec. 11, 2023 (DE) 102023134626.1

(51) Int. Cl. B65D 5/42; B65C 1/04; B65C 9/18

(52) U.S. Cl. CPC B65D 5/4212; B65C 1/04; B65C 9/1869; B65D 2203/02

(57) ABSTRACT

The disclosure relates to a packaging that is made from a packaging base for receiving a product and a lid part glued to opposite side walls of the packaging base, wherein the lid part comprises a self-adhesive label peeled off a carrier tape and having an underside provided with an adhesive exclusively in regions that are glued to the opposite side walls of the packaging base part. Furthermore, the disclosure relates to a method for producing a packaging.

### CROSS-REFERENCE TO RELATED APPLICATIONS

This application claims foreign priority benefits under 35 U.S.C. § 119(a)-(d) to German patent application number DE 102023134626.1, filed Dec. 11, 2023, which is incorporated by reference in its entirety.

### TECHNICAL FIELD

The present disclosure relates to a packaging and to a method for manufacturing a packaging.

### BACKGROUND

EP 2 666 728 B1 discloses a thermoforming packaging machine with a labeler. The labeler is arranged downstream of a sealing station of the thermoforming packaging machine and is configured to apply a label to each packaging cavity coming out of the sealing station and sealed therein with a top film. In this respect, the respective labels are separated from a carrier layer and glued to the lid part formed by the top film.

While in EP 2 666 728 B1 the top film supplied to the sealing station serves to seal the packaging cavities, the labels applied downstream by the labeler after the sealing process have the function of providing the sealed packages with information about the product they contain.

The disadvantage of this is that a relatively large amount of packaging material is used for packaging labeled in this way. In addition, a sealing station is required to produce the packaging.

In addition, the entire underside of the respective labels, in particular the full surface, is provided with adhesive in order to be able to fix them stably to the top film. Accordingly, in order to detach the respective labels from a carrier tape of a label roll, the carrier tape is coated over its entire surface, for example with a thin silicone layer or with a layer of varnish. As a result, the proportion of coating material on the carrier tape, in particular the silicone content of the carrier tape, may be relatively high, in particular higher than 20% of the total carrier material, which means that the carrier tape remaining after the labeling process may only be recycled with difficulty from material fractions that are roughly equal in quantity.

Furthermore, in practice label rolls are known that do not have a carrier layer, i.e., that consist only of a label tape. To prevent the wound label tape from sticking together, it is provided on its underside with an adhesive, for example with adhesive strips, and on its upper side with a corresponding coating, for example with a layer of varnish or with silicone strips, so that the adhesive provided on the underside covers the coating provided on the upper side when wound. In particular, the adhesive strips formed on the underside lie directly on the silicone strips provided along the upper side, so that the label roll does not require a separate carrier layer. This enables the production of packaging with reduced packaging material requirements. A disadvantage, however, is that the separation or cutting of labels from such a label roll may only be carried out directly on a labeling machine, and there also only with certain means, e.g. by means of a cutting blade installed thereon. This, however, only allows labels to be produced that have been cut straight. Above all, it is also disadvantageous that the packaging produced therefrom has labels that are coated on their upper side, in particular have traces of silicone.

### SUMMARY

The disclosure is based on the object of providing, against the background of the prior art described above, a sustainable packaging that may be produced at low cost, as well as a corresponding method for producing a packaging.

This object is solved by means of a packaging according to the disclosure and by means of a method according to disclosure.

The disclosure relates to a packaging that is made of a packaging base for holding a product and a lid part that is firmly glued to opposite side walls of the packaging base. According to the disclosure the lid is made of a self-adhesive label that has been peeled off a carrier tape and whose underside is provided with an adhesive only in regions that are glued to the opposite side walls of the packaging base. The adhesive portion present on the self-adhesive label is relatively small and limited to these regions.

The fact that the self-adhesive label itself is used on the packaging as a lid to close the packaging and that adhesive is only used in regions between the self-adhesive label and the side walls of the packaging base, and in these regions only partially, means that the packaging may be produced cost-effectively with reduced overall material requirement.

Furthermore, the self-adhesive label with partial adhesive may be recycled more efficiently. This is accompanied by the positive effect that the carrier tape for the self-adhesive labels may be produced with a correspondingly reduced coating, in particular with a very low silicone content, which, for example, may be less than 10%, possibly even less than 5%, of the total carrier tape material, so that the carrier tape as such is also better recyclable. A paper carrier tape may thus be recycled as paper despite the silicone strips provided for it, due to their negligible material content.

The fact that, in the packaging according to the disclosure, the lid part consists of a self-adhesive label peeled off a carrier tape enables production of a lid part without coating, in particular without a silicone strip on its upper side. Likewise, it is possible to produce self-adhesive labels with any label contours or self-adhesive labels in any shape on the carrier tape.

Preferably, the self-adhesive label is completely separated from the material from which the carrier tape is made. In other words, the lid part consists only of the self-adhesive label. This means that the carrier tape is left as a continuous band after the self-adhesive labels have been removed, i.e., no material is cut out of the carrier tape on the underside of the self-adhesive labels that have been removed. This means that the material is already cleanly separated when the self-adhesive labels are peeled off the carrier tape.

In one variant the underside is provided with the adhesive only in opposite edge regions, preferably up to the outer edges of the self-adhesive label. A substantial part of the underside, i.e., a region between the opposite edge regions provided with adhesive, is configured to be free of adhesive and may thus face the product without any neutralization measure.

According to one embodiment, the adhesive is formed in the form of strips on the underside of the self-adhesive label. These may be easily produced on the underside of the self-adhesive label. Accordingly, the carrier tape may be provided with silicone strips.

In particular, the self-adhesive label may be made of a plastic, in particular polypropylene (PP), of paper or of a cardboard. The adhesive content of the material from which the self-adhesive labels are made is in particular below 5%, so that the self-adhesive label may be recycled as plastic or as paper.

According to a preferred variant, the self-adhesive label is free of silicone on the side facing away from the product. This results in a visually appealing top side of the label. Without silicone (stripes) on the top side of the lid, the manufactured packages may also be stacked more efficiently because no unsightly silicone imprints then occur on the top side of the lid.

Preferably, the packaging base is a cardboard tray or a plastic tray. Preferably, the material of the packaging base corresponds to the material of the lid, that is, the material of the self-adhesive label. This results in packaging that has been sustainably produced.

Preferably, the self-adhesive label is glued to the outsides of the opposite side walls of the packaging base. This allows the opposite edges of the self-adhesive label to be folded along the tray edge of the packaging base, so that the lid parts made from the self-adhesive label are firmly attached and are stable under tensile and compressive loads. In addition, the lid part made from the self-adhesive label may be pressed firmly onto the outer sides of the opposite side walls using a partial adhesive. This allows even heavy products, such as products with high water content, such as fruit or vegetables, to be packaged with high sealing force.

In one variant adhesive-free (contact) regions between the underside of the self-adhesive label and the opposite side walls are provided on the opposite side walls above the regions where the self-adhesive label is glued. This is done to form non-adhesive zones so that the products, in particular food products, contained in the packaging base are at a sufficient distance from the adhesive regions formed between the lid part and the packaging base.

In particular, on the opposite side walls, below the regions where the pressure-sensitive label is adhered, adhesive-free (contact) regions are formed between the underside of the pressure-sensitive label and the opposite side walls. This leads to the formation of tear tabs on the package. Such a tear tab may also be formed on one side of the lid part only below a zone provided with adhesive.

According to one embodiment, the self-adhesive label is formed with a plurality of holes. The holes are distributed in particular so as to create windows through which the products contained in the packaging may be visible from the outside.

It is considered that the self-adhesive label is printed on its upper side with a motif, for example with a motif that represents the packaged product. Alternatively or in addition, the motif may also be a code that contains information relating to the packaged product, e.g. a bar code.

The self-adhesive label may have cut-outs along its perimeter, in particular rounded cut-outs opposite to one another. These cut-outs in the perimeter provide an option for an enlarged viewing area. If the self-adhesive label itself is not made of a transparent material, the cut-outs may support the product inside the packaging to become visible from the outside.

In one variant the self-adhesive label has at least one perforation between the regions provided with adhesive. This perforation may be produced on the self-adhesive label in particular along a side wall of the packaging base, above and along a region provided with adhesive as a tear aid. A perforation of this kind may also be present on both sides of the packaging. This allows the regions of the self-adhesive label provided with adhesive to remain on the packaging base when the self-adhesive label is separated from it. This has advantages for recycling, since the separated part of the self-adhesive label is without adhesive, i.e., it may be disposed of as pure material, e.g. as cardboard. The adhesive on the remaining part of the self-adhesive label on the packaging base makes up only a very small proportion of the material from which the packaging base is made, so that the packaging base may basically also be recycled as pure material, e.g. as cardboard.

The disclosure also relates to a method for producing a packaging. The method according to the disclosure provides for a self-adhesive label, which is provided with an adhesive on its underside exclusively in regions, in which it is to be glued to opposite side walls of a provided packaging base, to be separated from a carrier tape of a provided label roll and glued as a lid part to the opposite side walls of the provided packaging base.

Thus, relatively little adhesive is needed to produce the packaging. Furthermore, the carrier tape material may be produced with a very low proportion of varnish or silicone, in particular with a silicone content of less than 5% of the total carrier tape material, because silicone regions on the surface of the carrier tape may be reduced in area to match the respective regions of adhesive partially applied to the underside of the self-adhesive label.

In addition, the self-adhesive label may be easily peeled off the carrier tape because the adhesive is only partially applied to its underside. This means that labeling, i.e., separating and applying the lid to the packaging base, may take place at a higher production speed.

In addition, the self-adhesive labels provided on the carrier tape, which, according to the disclosure, are used as lids themselves, may be produced in any label shape or with any label contour, and are characterized in particular by a silicone-free upper side. The fact that the carrier tape remains as a continuous band when the self-adhesive labels are separated therefrom results in a clean material separation between the self-adhesive label material and the carrier tape material. This also means that the prefabrication of the carrier tape involves little effort.

Preferably, when the self-adhesive label is separated from the carrier tape, the self-adhesive label is completely separated from the material from which the carrier tape is made. This means that, when the self-adhesive label is peeled off the carrier tape, no pieces of the carrier tape remain on the underside of the self-adhesive label, but the carrier tape remains as a continuous tape. The lid part thus consists of the material of the self-adhesive label only, resulting in a sustainable packaging with reduced material overall.

Preferably, when the self-adhesive label is separated from the carrier tape, the regions on the underside of the self-adhesive label that are provided with the adhesive are separated from the silicone regions on the carrier tape that are adapted to them in terms of area. This means that only a small amount of silicone is needed on the carrier tape. It is conceivable that the silicone content on the carrier tape accounts for less than 5% of the total carrier material, making the carrier tape material more recyclable. In particular, a carrier tape made of paper may be recycled as paper with a silicone content of less than 5%.

In particular, it may be provided that, by separating all self-adhesive labels from the carrier tape of the label roll, a carrier tape material remains with a silicone content of less than 10%, preferably less than 7%, further preferably less than 5%. Such a residual carrier material may easily be shredded, in particular right at the place where the packaging is produced, for example by means of a knife device associated with the labeling machine, in order to be better suited for logistical purposes in shredded form.

The fact that the adhesive applied to the packaging according to the disclosure on the lid part formed by the self-adhesive label is only applied in the regions where the lid part is glued to the packaging base, and that the method according to the disclosure may produce packaging with lids made of self-adhesive labels with reduced adhesive, there is an increased potential for savings, since relatively little adhesive is used overall and, furthermore, a reduced amount of varnish or silicone on the carrier tape is possible. This cost-saving potential is accompanied by the advantage of recyclable materials, since the overall amount of adhesive or silicone material on the packaging material or on the material of the remaining carrier tape is negligible. In addition, the disclosure offers advantages in the production of contoured label shapes and visual advantages in the lid parts made from self-adhesive labels without silicone strips.

It is considered that a label roll used for the packaging according to the disclosure or for the method for producing a packaging according to the disclosure is produced as follows:
providing a material web having a carrier layer and a label layer that is glued to the carrier layer by means of adhesive strips spaced apart from one another,
punching or lasing the label layer to define self-adhesive labels on the carrier layer with a shape predetermined by the punching or lasing, so that the punched or lasered self-adhesive labels form lid parts, on the underside of which, exclusively in regions that are to be glued to opposite side walls of packaging bases, sections of the adhesive strips are produced,
peeling off the matrix formed by punching or lasing the label layer, so that individual self-adhesive labels with the predetermined shape remain on the carrier layer,
winding the web of material pre-cut by punching or lasering into a roll of self-adhesive labels, which are provided with an adhesive on their underside only in regions that are to be glued to opposite side walls of packaging bases.

### BRIEF DESCRIPTION OF THE DRAWINGS

The disclosure is explained in more detail using the examples shown in the figures. In the figures:

FIG. 1 shows a packaging in a schematic cross-section;

FIG. 2 is a schematic side view of the packaging shown in FIG. 1;

FIG. 3 shows the underside of a lid part made from a self-adhesive label of the packaging shown in FIGS. 1 and 2;

FIG. 4 shows a label roll according to a first embodiment in a schematic representation;

FIG. 5 shows a label roll according to a second embodiment in a schematic representation;

FIG. 6 shows a carrier tape of the label rolls shown in FIGS. 4 and 5 in an isolated representation; and

FIG. 7 shows a labeling machine for producing packages according to the disclosure.

Same components are provided with the same reference signs throughout the figures.

### DETAILED DESCRIPTION

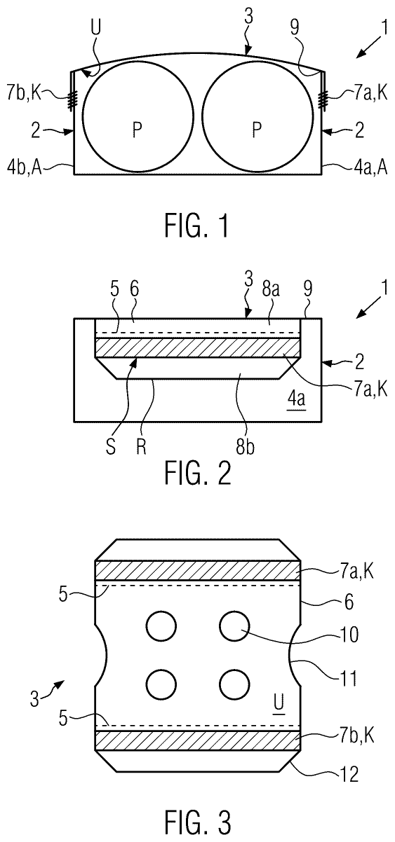

FIG. 1 shows a packaging 1 that is made from a packaging base 2 for holding a product P and from a lid part 3. The lid part 3 is firmly glued to opposite side walls 4a, 4b of the packaging base 2.

According to FIG. 1, the lid part 3 consists of a self-adhesive label 6 peeled off from a carrier tape 14 (see FIG. 5). The self-adhesive label 6 is provided on its underside U (see FIG. 3) with an adhesive K only in regions 7a, 7b, which are glued to the opposite side walls 4a, 4b of the packaging base 2. Between the regions 7a, 7b formed with adhesive K, no further adhesive K is formed on the underside U of the self-adhesive label 6.

As shown in FIG. 1, the self-adhesive label 6 is glued along the outer sides A of the opposite side walls 4a, 4b. This means that the self-adhesive label 6 is folded over a packaging edge 9 of the packaging base 2, above the regions 7a, 7b provided with adhesive K.

FIG. 2 shows the packaging 1 from FIG. 1 in a side view. FIG. 2 shows that the region 7a of the self-adhesive label 6 provided with adhesive K is in the form of a strip S. Furthermore, FIG. 2 shows that an adhesive-free region 8a is formed between the underside U of the self-adhesive label 6 and the side wall 4a on the side wall 4a above the region 7a in which the self-adhesive label 6 is glued. A perforation 5 is formed in the region 8a. Furthermore, below the region 7a, a further adhesive-free region 8b is formed between the underside U of the self-adhesive label 6 and the side wall 4a. The adhesive-free region 8a ensures that the adhesive K does not come into contact with the product P contained in the packaging base 2. The further adhesive-free region 8b may be used as a tear tab for opening the packaging 1.

It is considered herein that, in the packaging 1 shown in FIG. 2, the region 7a, in which the self-adhesive label 6 is glued to the side wall 4a, may be formed up to an edge R of the self-adhesive label 6, i.e., the self-adhesive label 6 is present without the region 8b, i.e., without a tear-open tab.

FIG. 3 shows the self-adhesive label 6 from below in an isolated view. The self-adhesive label 6 has on its underside U the regions 7a, 7b, which are provided with adhesive K. In these regions 7a, 7b, the adhesive K may be formed in a predetermined pattern.

The regions 7a, 7b are each present in FIG. 3 in the form of strips S. The self-adhesive label 6 shown in FIG. 3 has holes 10 that serve as peepholes. Furthermore, the self-adhesive label 6 in FIG. 3 has opposite rounded cut-outs 11 along its perimeter. Corners 12 of the self-adhesive label 6, shown in isolation in FIG. 3, are slanted. The slanted corners 12, the holes 10 and the cut-outs 11 may be made by punching or by laser cutting.

The regions 7a, 7b shown in FIGS. 1 to 3, in which the self-adhesive label 6 is glued to the opposite side walls 4a, 4b of the packaging base 2, may vary in shape depending on the overlap area created between the self-adhesive label 6 and the packaging base 2.

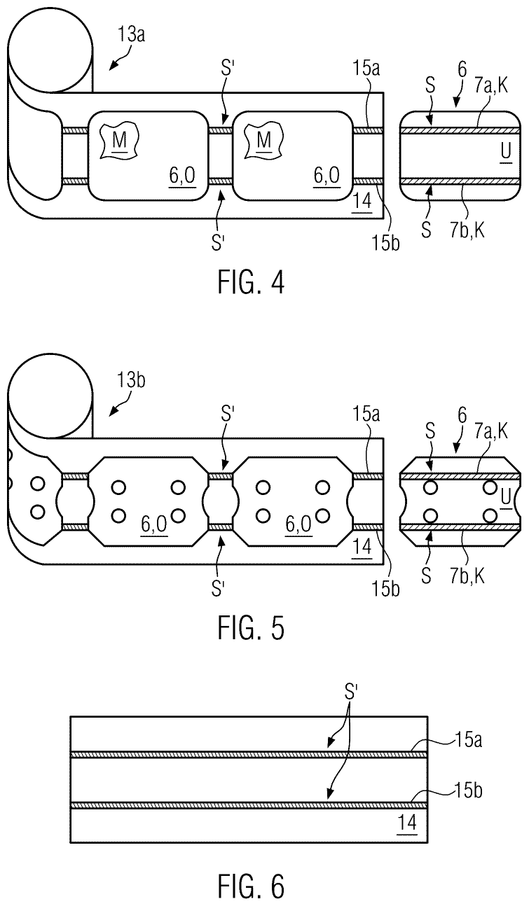

FIG. 4 shows a label roll 13a. The label roll 13a has a carrier tape 14 and self-adhesive labels 6 glued thereon. The self-adhesive labels 6 of the label roll 13a are glued to the carrier tape 14 by means of the regions 7a, 7b of adhesive K formed on their underside U along silicone regions 15a, 15b correspondingly produced on the carrier tape 14. The silicone regions 15a, 15b are thus also present as strips S′. The strips S of adhesive K produced on the underside U of the self-adhesive labels 6 thus coincide with the strips S′ of silicone produced along the carrier tape 14. Between the spaced-apart strips S′ of silicone, the self-adhesive labels 6 are not glued to the carrier tape 14, but lie unconnected on the carrier tape 14 in this region. A motif M is provided on an upper side O of the self-adhesive labels 6.

FIG. 4 also shows a self-adhesive label 6 separated from the carrier tape 14, with strips S of adhesive K formed on its underside U.

FIG. 5 shows a further label roll 13b. The self-adhesive labels 6 glued to the carrier tape 14 in FIG. 5 are produced according to the shape of the self-adhesive label 6 shown in FIG. 3. These self-adhesive labels 6 are also glued to the carrier tape 14 along the regions 15a, 15b, that is, along the strips S′ of silicone, by means of the strips S of adhesive K that are produced on their underside U.

FIG. 5 also shows a self-adhesive label 6 that has been separated from the carrier tape 14 and has strips S of adhesive K formed on its underside U.

The respective self-adhesive labels 6, which are glued to the respective carrier tape 14 as shown in FIGS. 4 and 5, may have any label shape, in particular they may form a desired lid geometry with regard to the format of a packaging base 2.

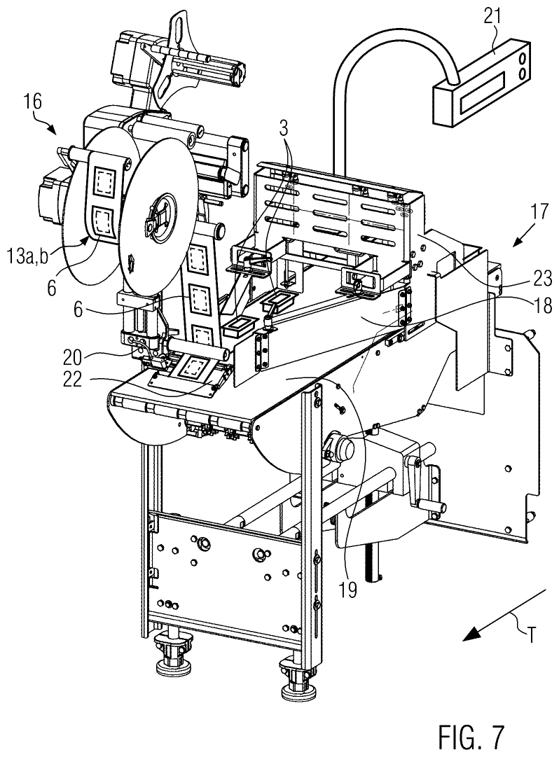

FIG. 6 shows the carrier tape 14 in an isolated representation, i.e., without self-adhesive labels 6 glued thereto. It is evident that the silicone strips S′ produced on the carrier tape 14 are parallel to each other. A label layer (not shown) may be attached along the silicone strips S′ during the production of the self-adhesive labels 6. This label layer may then be cut by punching or lasing to produce self-adhesive labels 6 with a desired self-adhesive label shape on the carrier layer 14. The scrap web formed along the label layer is removed, so that only individual self-adhesive labels 6, for example in the form of the self-adhesive labels 6 shown in FIG. 4 and/or FIG. 5, remain on the carrier layer 14 after punching or lasing. Thereafter, the now prefabricated material web consisting of the carrier web 14 and the self-adhesive labels 6 cut out from the label layer attached to the carrier web is wound up to be used as a label roll 13a, 13b on a labeling machine 16 (see FIG. 7).

FIG. 6 shows that the silicone proportion on the carrier tape 14, which is produced by the silicone strips S′, only makes up a small portion of the entire carrier tape material, in particular less than 5% of the entire carrier tape material. This means that, for example, a paper carrier tape 14 may be recycled despite the silicone strips S′ formed thereon. In combination with a paper self-adhesive label 6, this forms a particularly sustainable packaging 1.

FIG. 7 shows a labeling machine or labeller 16 with a feed device 17 that is configured as a line combiner, as shown in FIG. 7. The feed device 17 is used to feed packaging bases 2 that are loaded with product P but not yet provided with a lid part 3 to the labeling machine 16. Two guide rails 18 are positioned so that they converge towards each other in such a way that a gap or opening for packaging bases 2 is created at the end of the guide rails 18 located downstream in the direction of production T, which is only slightly wider than the width of the packaging bases 2 themselves.

This allows the packaging bases 2, which are transported on the feeding device 17 by means of a conveyor belt 19 running thereon, to be fed precisely to the labeling machine 16. This in turn makes it possible for a self-adhesive label 6 to be peeled off the label roll 13a, 13b and, after being drawn off the carrier tape 14, to be glued precisely onto a supplied packaging base 2 in order to close the packaging base 2.

A sensor 20 provided on the labeling device 16 may detect a front edge of a packaging base 2 to be labeled and closed while the packaging base 2 is being transported along the guide rails 18. The sensor 20 may be configured as a light barrier or a proximity sensor and is connected to a controller 21 and transmits the signal, namely the detection of the front edge of the packaging base 2, to the controller. The controller 21 controls the movement of the self-adhesive label 6 to be dispensed by means of the speed and path of a label roll 13a, 13b attached to the labelling machine 16, to and along a dispensing edge 22, in order to detach the self-adhesive label 6 from the label roll 13a, 13b and apply it to the packaging base 2.

Preferably, the speed of the label roll 13a, 13b during the dispensing process onto the packaging base 2 is identical to the speed of the conveyor belt 19.

Upstream of the labeling device 16, a stopper device 23 is arranged on the feeding device 17 in front of the guide rails 18 to stop the packaging bases 2 while the conveyor belt 19 is running. Stopped packaging bases 2 may thus be released one by one for the labeling process, i.e., for the tray closing process at the labeling device 16.

What is claimed is:

1. A packaging comprising a packaging base for receiving a product and a lid part glued to opposite side walls of the packaging base, wherein the lid part comprises a self-adhesive label peeled off a carrier tape and having an underside provided with an adhesive exclusively in regions glued to the opposite side walls of the packaging base.

2. The packaging according to claim 1, wherein the self-adhesive label is completely separated from a material from which the carrier tape is made.

3. The packaging according to claim 1, wherein the underside is provided with the adhesive in opposite edge regions only.

4. The packaging according to claim 1, wherein the underside is provided with the adhesive in opposite edge regions only, up to outer edges of the self-adhesive label.

5. The packaging according to claim 1, wherein the adhesive is formed as strips on the underside of the self-adhesive label.

6. The packaging according to claim 1, wherein the self-adhesive label is made of plastic, of paper or of a cardboard.

7. The packaging according to claim 6, wherein the self-adhesive label comprises polypropylene.

8. The packaging according to claim 1, wherein an upper side of the self-adhesive label facing away from the product is free of silicone.

9. The packaging according to claim 1, wherein the packaging base is a cardboard tray or a plastic tray.

10. The packaging according to claim 1, wherein the self-adhesive label is glued to outer sides of the opposite side walls of the packaging base.

11. The packaging according to claim 1, wherein, on the opposite side walls above the regions in which the self-adhesive label is glued, adhesive-free contact regions are formed between the underside of the self-adhesive label and the opposite side walls.

12. The packaging according to claim 1, wherein the self-adhesive label is configured with a plurality of holes and/or is printed on its upper side with a motif.

13. The packaging according to claim 1, wherein the self-adhesive label has, along its perimeter, cut-outs.

14. The packaging according to claim 13, wherein the cut-outs are formed as rounded cut-outs, located opposite to one another.

15. A method for producing a packaging, comprising separating a self-adhesive label, provided with an adhesive on its underside exclusively in regions to be glued to opposite side walls of a provided packaging base of the packaging, from a carrier tape of a provided label roll, and gluing the self-adhesive label as a lid part to the opposite side walls of the provided packaging base.

16. The method according to claim 15, wherein, by separating the self-adhesive label from the carrier tape, the self-adhesive label is completely separated from a material from which the carrier tape is made.

17. The method according to claim 15, wherein, upon separating the self-adhesive label from the carrier tape, the regions present on the underside of the self-adhesive label and provided with the adhesive are separated from silicone regions, formed on the carrier tape and being adapted to the regions in terms of surface area.

18. The method according to claim 15, wherein, by separating all of the self-adhesive labels from the carrier tape of the label roll, a carrier tape material remains that has a silicone content of less than 10%.

19. The method according to claim 15, wherein, after separating the self-adhesive label and any additional self-adhesive labels from the carrier tape of the label roll, a carrier tape material remains that has a silicone content of less than 7%.

20. The method according to claim 19, wherein the silicone content of the carrier tape material is less than 5%.
